(19) United States
(12) Patent Application Publication
(10) Pub. No.: US 2012/0182951 A1
(43) Pub. Date: Jul. 19, 2012

(54) RADIO BASE STATION AND MOBILE STATION

(75) Inventors: Naoto Okubo, Yokosuka-shi (JP); Sadayuki Abeta, Yokohama-shi (JP)

(73) Assignee: NTT DOCOMO, INC., Tokyo (JP)

(21) Appl. No.: 13/390,853

(22) PCT Filed: Aug. 13, 2010
(86) PCT No.: PCT/JP2010/063768

§ 371 Date: Mar. 29, 2012

(30) Foreign Application Priority Data
Aug. 17, 2009 (JP) 2009-188645

(51) Int. Cl. H04W 56/00; H04W 88/00; H04W 72/04

(52) U.S. Cl. 370/329

(57) ABSTRACT

A radio base station eNB according to the present invention includes: a synchronization signal transmission unit 10 configured to transmit a synchronization signal including a cell ID assigned to a subordinate cell #1; a broadcast information transmission unit 11 configured to transmit broadcast information including a virtual cell ID assigned to the cell #1; and an RS transmission unit 14 configured to transmit CRS (first reference signal) determined uniquely by the cell ID and transmit PRS (second reference signal) determined uniquely by the virtual cell ID, wherein a range of values assignable as the virtual cell ID is configured to be larger than a range of values assignable as the cell ID.

### TECHNICAL FIELD

The present invention relates to a radio base station and a mobile station.

### BACKGROUND ART

In a standards determination work of an LTE (Long Term Evolution)-Rel.9 scheme, the introduction of PRS (Positioning Reference Signal) has been examined, which can be transmitted with a density higher than CRS (Common Reference Signal) in order to measure a propagation delay difference from each cell in a mobile station UE.

### SUMMARY OF THE INVENTION

### Problems to be Solved by the Invention

However, the following problem exists: if the completely same series is used between the PRS series and the CRS series, then because the power density of the PRS is higher than the power density of the CRS, it is highly likely that a conflict between PRSs having the same series may occur, unless a cell arrangement planning in the LTE-Rel. 8 scheme is redesigned.

In this regard, the present invention has been made in view of the aforementioned problems and an object thereof is to provide a radio base station and a mobile station, by which it is possible to reduce a probability of the conflict generated between PRSs having the same series without a need of redesigning a cell arrangement planning designed with a view toward CRS.

### Means for Solving the Problem

A first characteristic of the present invention is summarized as a radio base station comprising, a synchronization signal transmission unit configured to transmit a synchronization signal including a cell ID assigned to a subordinate cell, a broadcast information transmission unit configured to transmit broadcast information including a virtual cell ID assigned to the subordinate cell, a first reference signal transmission unit configured to transmit a first reference signal uniquely determined by the cell ID, and a second reference signal transmission unit configured to transmit a second reference signal uniquely determined by the virtual cell ID, in which a range of values assignable as the virtual cell ID is configured to be larger than a range of values assignable as the cell ID.

A second characteristic of the present invention is summarized as a mobile station comprising, a synchronization information reception unit configured to receive synchronization information in a particular cell, a broadcast information reception unit configured to receive broadcast information in the particular cell, a first reference signal reception unit configured to receive a first reference signal in the particular cell using a cell ID included in the received synchronization signal, and a second reference signal reception unit configured to receive a second reference signal in the particular cell using a virtual cell ID included in the received broadcast information, in which a range of values assignable as the virtual cell ID is configured to be larger than a range of values assignable as the cell ID.

### Effect of the Invention

As described above, according to the present invention, it is possible to provide a radio base station and a mobile station, by which it is possible to reduce a probability of the conflict generated between PRSs having the same series without a need of redesigning a cell arrangement planning designed with a view toward CRS.

### BRIEF DESCRIPTION OF THE DRAWINGS

FIG. 1 is a diagram illustrating the entire configuration of a mobile communication system according to a first embodiment of the present invention.

FIG. 2 is a functional block diagram illustrating a radio base station according to the first embodiment of the present invention.

FIG. 3 is a diagram illustrating PRS transmitted by the radio base station according to the first embodiment of the present invention.

FIG. 4 is a functional block diagram illustrating the mobile station according to the first embodiment of the present invention.

FIG. 5 is a sequence diagram illustrating the operation of the mobile communication system according to the first embodiment of the present invention.

### BEST MODES FOR CARRYING OUT THE INVENTION

### Configuration of Mobile Communication System According to First Embodiment of the Present Invention

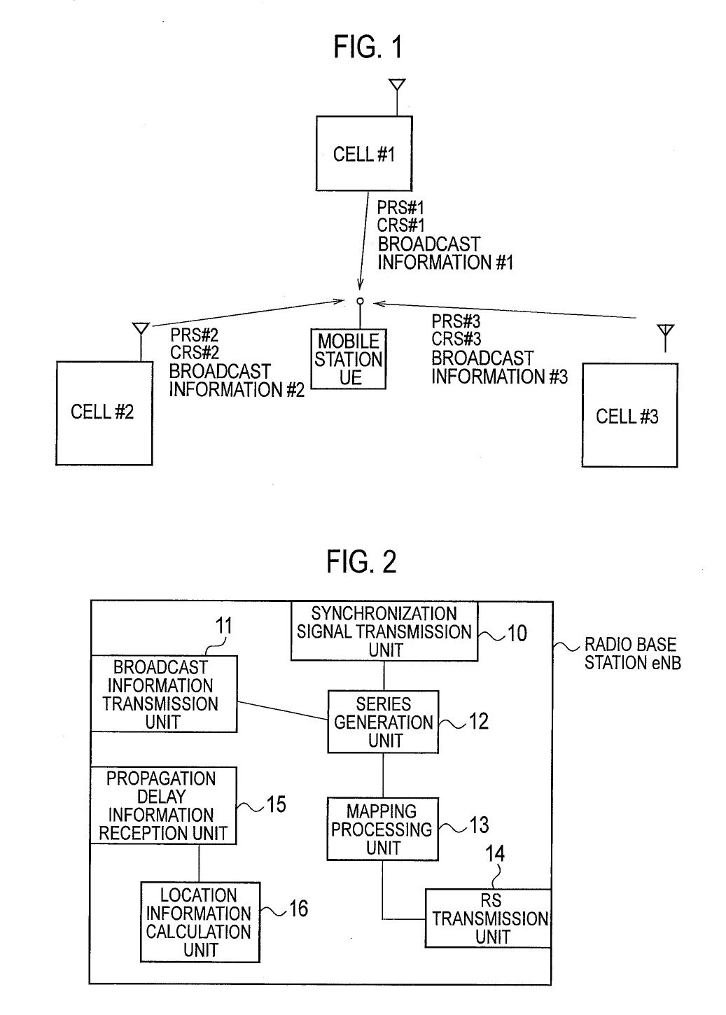

The configuration of a mobile communication system according to a first embodiment of the present invention will be described with reference to FIGS. 1 to 4.

The mobile communication system according to the present embodiment is a mobile communication system complying with an LTE-Rel. 9 scheme. As illustrated in FIG. 1, the mobile communication system according to the present embodiment is configured such that a mobile station UE may receive broadcast information #1 to #3, PRS#1 to PRS#3, or CRS#1 to CRS#3, from a plurality of cells #1 to #3, respectively.

According to the present embodiment, description will be made for a case where the mobile station UE completes connection to the cell#1 and camps on the cell#1, the mobile station UE measures a propagation delay from the cells #1 to #3, and the propagation delay is reported to the radio base station eNB.

Note that the cells #1 to #3 may be managed by the same radio base station eNB or managed by a plurality of radio base stations eNBs. Hereinafter, in the present embodiment, it is assumed that the cells #1 to #3 are managed by the same radio base station eNB.

As illustrated in FIG. 2, the radio base station eNB includes a synchronization signal transmission unit 10, a broadcast information transmission unit 11, a series generation unit 12, a mapping processing unit 13, an RS transmission unit 14, a propagation delay information reception unit 15, and a location information calculation unit 16.

The synchronization signal transmission unit 10 is configured to transmit a synchronization signal in a cell subordinate to the radio base station eNB.

Such a synchronization signal is configured by two synchronization signals of a primary synchronization signal (P-SS) and a secondary synchronization signal (S-SS) and these synchronization signals correspond to a cell ID one to one.

The broadcast information transmission unit 11 is configured to transmit the broadcast information in the cell subordinate to the radio base station eNB.

Such broadcast information includes virtual cell IDs assigned to each cell #1 to #3, and the mobile station UE is notified of the virtual cell ID assigned to a cell in which the mobile station UE intends to measure a delay amount.

The series generation unit 12 is configured to generate a CRS series and a PRS series.

For example, the series generation unit 12 may be configured to generate the CRS series (CRS defined in 3GPP TS36.211) and the PRS series based on Equation 1.

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , m = 0 , 1 , … , 2 {N}_{RB}^{RS} - 1 \qquad [ Equation 1 ]$$

where, “r_{l, ns}(m)” denotes an m-th sample in an l-th OFDM symbol within a slot having a slot number ns. In addition, “N_{RB}^{RS}” denotes the number of resource blocks (RBs) that transmit the CRS or PRS and is a parameter included in the aforementioned broadcast information.

In addition, “c(m)” denotes a random series, and in the case of CRS, is initialized based on Equation 2.

cᵢₙᵢₜ=2¹⁰·(7·(nₛ+1)+I+1)·(2·N_{ID}^{cell}+1)+2·N_{ID}^{cell}+N_{CP} [Equation 2]

where, “N_{ID}^{cell}” denotes a cell ID assigned to each cell, and “N_{CP}” denotes a variable defined in Equation 3.

$${N}_{CP} = \{ \begin{matrix}1 & for normal CP \\ 0 & for extended CP\end{matrix} \qquad [ Equation 3 ]$$

Meanwhile, in the case of PRS, c(m) is initialized based on Equation 4.

cᵢₙᵢₜ=2¹⁰·(7·(nₛ+1)+I+1)·(2·N_{ID}^{virtual}^{_{—}}^{cell}+1)+2·N_{ID}^{virtual}^{_{—}}^{cell}+N_{CP} [Equation 4]

where, “N_{ID}^{virtual}^{_{—}}^{cell}” denotes the virtual cell ID assigned to each cell.

As described above, the configuration is such that the CRS series is uniquely determined by the cell ID, and the PRS series is uniquely determined by the virtual cell ID.

Here, the configuration is such that the range of values assignable as the virtual cell ID is larger than the range of values assignable as the cell ID. For example, the range of values assignable as the virtual cell ID may be set to “0 to 1007”, and the range of values assignable as the cell ID may be set to “0 to 504”.

The mapping processing unit 13 is configured to map the CRS series and the series of each PRS #1 to #3 generated by the series generation unit 12 to a resource element (RE).

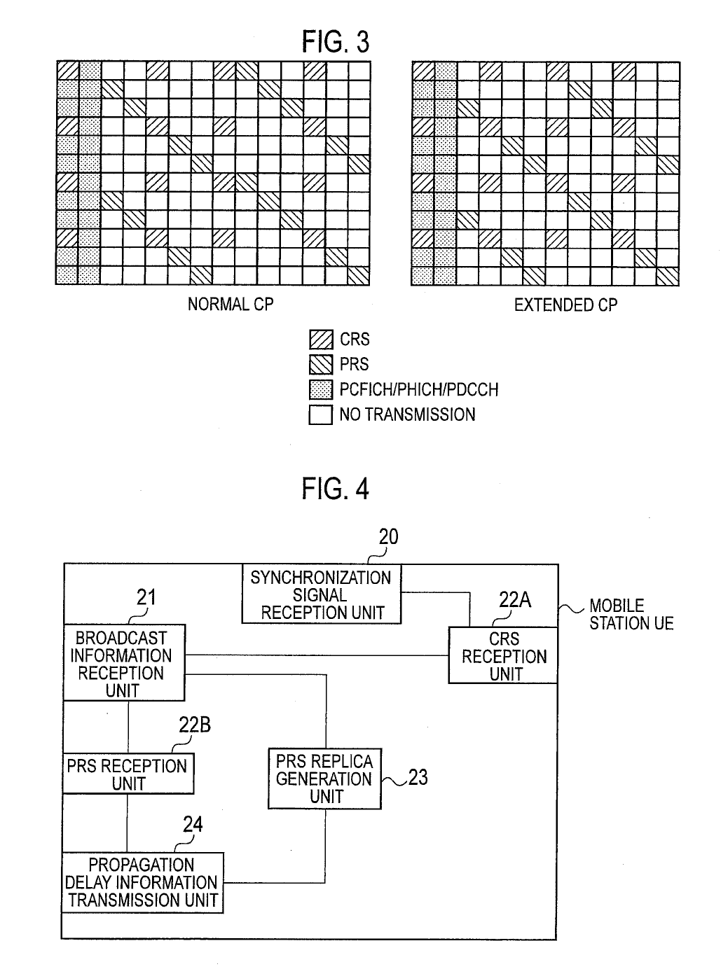

For example, as illustrated in FIG. 3, the mapping processing unit 13 may be configured to map the CRS series and the PRS series to each resource element within each resource block.

Specifically, the mapping processing unit 13 may be configured to map the PRS series to the resource element specified by Equation 5.

a_{k,l}=r_{l,n}_{ₛ}(m′) [Equation 5]

where, “a_{k,l}” denotes a symbol of a resource element in a k-th sub-carrier and an l-th OFDM symbol. Note that the sub-carrier k and the OFDM symbol index I are determined based on Equation 6.

$$k = 6 m + ( 6 - l + {v}_{shift} ) mod 6 \\ l = \{ \begin{matrix}3 , 5 , 6 & if {n}_{s} mod 2 = 0 \\ 1 , 2 , 3 , 5 , 6 & \begin{matrix}if {n}_{s} mod 2 = 1 and \\ ( 1 or 2 PBCH antenna ports )\end{matrix} \\ 2 , 3 , 5 , 6 & \begin{matrix}if {n}_{s} mod 2 = 1 and \\ ( 4 PBCH antenna ports )\end{matrix}\end{matrix} \\ m = 0 , 1 , … , 2 \cdot {N}_{RB}^{PRS} - 1 \\ {m}^{′} = m + {N}_{RB}^{max , DL} - {N}_{RB}^{PRS} \\ [ {v}_{shift} = ( {\sum }_{i = 0}^{7} {2}^{i} c ( i + 8 ⌊ \frac{{n}_{s}}{2} ⌋ ) ) mod 6 ] \\ {c}_{init} = {N}_{Cell}^{ID} \qquad [ Equation 6 ]$$

The RS transmission unit 14 is configured to transmit the resource block where the CRS and the PRS are mapped by the mapping processing unit 13 in each cell.

In addition, the RS transmission unit 14 is configured to be notified, from an upper layer, of a frequency bandwidth (number of resource blocks) or a transmission interval (transmission timing) for transmitting the PRS.

In addition, the RS transmission unit 14 may be configured such that in the resource blocks that transmits the PRS, downlink data on a physical downlink shared_channel (PDSCH) is not transmitted. As a result, it is possible to improve the timing detection accuracy of the PRS.

The propagation delay information reception unit 15 is configured to receive the propagation delay information transmitted by the mobile station UE via a physical uplink shared channel (PUSCH).

The location information calculation unit 16 is configured to calculate the location information of the mobile station UE based on the propagation delay information received by the propagation delay information reception unit 15.

For example, the location information calculation unit 16 may be configured to calculate the location information of the mobile station UE based on an observed time difference of arrival (OTDOA) scheme. In this case, the propagation delay information includes the propagation delay in at least three cells specified by the broadcast information from the radio base station eNB.

According to the present embodiment, since the mobile station UE measures the propagation delay using the PRS from the cells #1 to #3, the propagation delay from the cells #1 to #3 is reported to the radio base station eNB.

In addition, the location information calculation unit 16 may be included as a function of the radio base station eNB or may be included in a node different from the radio base station eNB, for example, a serving mobile location center (SMLC) that is an upper node.

As illustrated in FIG. 4, the mobile station UE includes a synchronization signal reception unit 20, a broadcast information reception unit 21, a CRS reception unit 22A, a PRS reception unit 22B, a PRS replica generation unit 23, and a propagation delay information transmission unit 24.

The synchronization signal reception unit 20 is configured to receive the synchronization signal including the cell ID of the radio base station eNB to which the mobile station UE connects.

The broadcast information reception unit 21 is configured to receive broadcast information from the cell specified by the cell ID detected by the aforementioned synchronization signal, that is, the cell to which the mobile station UE connects.

The CRS reception unit 22A is configured to receive the CRS in the cell to which the mobile station UE connects, by using the cell ID included in the received synchronization signal. Specifically, the CRS reception unit 22A is configured to receive the CRS in the cells #1 to #3 with reference to the Equations 1 to 3, 5, and 6 described above, and the like.

The mobile station UE estimates a propagation state from the cell #1, from the received CRS, by using a replica signal of the connecting cell #1, and demodulates the broadcast information transmitted from the cell #1 and a data signal such as PDSCH.

The PRS reception unit 22B is configured to receive the PRS in the cells #1 to #3. Specifically, the PRS reception unit 22B is configured to receive the PRS in the cells #1 to #3 with reference to Equations 1 and 3 to 6 described above, and the like.

The PRS replica generation unit 23 is configured to generate a PRS replica in the cells #1 to #3, by using the virtual cell ID included in the received broadcast information. Specifically, the PRS replica generation unit 23 is configured to generate the PRS replica in the cells #1 to #3 with reference to Equations 1 and 3 to 6 described above, and the like.

The propagation delay information transmission unit 24 is configured to calculate, based on the PRS in the cells #1 to #3 received by the PRS reception unit 22B and the PRS replica in the cells #1 to #3 generated by the PRS replica generation unit 23, the propagation delay in the cells #1 to #3, and transmit the propagation delay information indicating such a propagation delay and the virtual cell ID obtained by measuring the propagation delay, to the radio base station eNB.

Note that the mobile station UE may measure a delay amount from the virtual cell ID that can be detected with high accuracy, by using not only the PRS from the virtual cell ID specified by the received broadcast information but also the PRSs from other virtual cell IDs.

### Operation of the Mobile Communication System According to the First Embodiment of the Present Invention

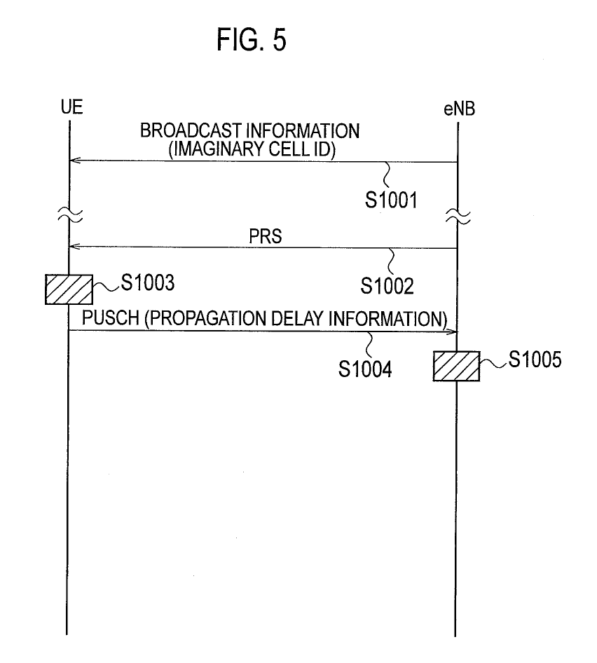

The operation of the mobile communication system according to the first embodiment of the present invention will be described with reference to FIG. 5.

As illustrated in FIG. 5, in step S1001, the radio base station eNB transmits the broadcast information including the virtual cell ID assigned to each cell #1 to #3 as a target cell of which the propagation delay is measured. Here, the mobile station UE receives the broadcast information #1 from the connection-destination cell #1 notified from the radio base station eNB.

In step S1002, the radio base station eNB transmits the PRSs #1 to #3 in the cells #1 to #3.

In step S1003, the mobile station UE receives the PRSs #1 to #3 in the cells #1 to #3, by using the virtual cell ID included in the received broadcast information #1.

In step S1004, the mobile station UE calculates the propagation delay in the cells #1 to #3 by using the received broadcast information #1 and the PRSs #1 to #3, and transmits the propagation delay information indicating such a propagation delay, via the PUSCH, to the radio base station eNB.

In step S1005, the radio base station eNB calculates the location information of the mobile station UE by using the received propagation delay information.

### Operation and Effect of the Mobile Communication System According to the First Embodiment of the Present Invention

According to the mobile communication system based on the first embodiment of the present invention, the configuration is such that the CRS series is uniquely determined by the cell ID, the PRS series is uniquely determined by the virtual cell ID, and the range of values assignable as the virtual cell ID is larger than the range of values assignable as the cell ID, and therefore, it is possible to increase a distance between cells using the PRSs of the same series than a distance between cells using the CRSs of the same series, resulting in reducing a conflict between PRSs of the same series without a need of redesigning the cell designed by focusing on the CRS.

According to the mobile communication system based on the first embodiment of the present invention, it is possible to provide a location service (LCS) by calculating location information of the mobile station UE based on the propagation delay in a plurality of cells calculated by the mobile station UE.

The above characteristics of the present embodiment may be expressed as follows:

A first characteristic of the present embodiment is a radio base station eNB including: a synchronization signal transmission unit 10 configured to transmit a synchronization signal including a cell ID assigned to a cell #1 in the subordinate cell #1; a broadcast information transmission unit 11 configured to transmit broadcast information including a virtual cell ID assigned to the cell #1; and an RS transmission unit 14 configured to transmit CRS (first reference signal) uniquely determined by the cell ID and transmit PRS (second reference signal) uniquely determined by the virtual cell ID, wherein a range of values assignable as the virtual cell ID is configured to be larger than a range of values assignable as the cell ID.

In the first characteristic of the present embodiment, a propagation delay information reception unit 15 configured to acquire propagation delay information from the mobile station UE; and a location information calculation unit 16 configured to calculate location information of the mobile station UE based on the acquired propagation delay information may be further provided.

A second characteristic of the present embodiment is a mobile station UE including: a synchronization signal reception unit 20 configured to receive a synchronization signal in a cell #1; a broadcast information reception unit 21 configured to receive broadcast information in the cell #1; a CRS reception unit 22A configured to receive CRS in the cell #1 using a cell ID included in the received synchronization signal; and a PRS reception unit 22B configured to receive PRS in the cells #1 to #3 using a virtual cell ID included in the received broadcast information, wherein a range of values assignable as the virtual cell ID is configured to be larger than a range of values assignable as the cell ID.

In the second characteristic of the present embodiment, a propagation delay information transmission unit 24 configured to calculate a propagation delay from a plurality of cells #1 to #3 based on the PRS received in a plurality of cells #1 to #3 and transmit propagation delay information indicating the propagation delay to a predetermined radio base station eNB may be further provided.

It is noted that the operation of the above-described the radio base station eNB or the mobile station UE may be implemented by a hardware, may also be implemented by a software module executed by a processor, and may further be implemented by the combination of the both.

The software module may be arranged in a storage medium of an arbitrary format such as RAM (Random Access Memory), a flash memory, ROM (Read Only Memory), EPROM (Erasable Programmable ROM), EEPROM (Electronically Erasable and Programmable ROM), a register, a hard disk, a removable disk, and CD-ROM.

The storage medium is connected to the processor so that the processor can write and read information into and from the storage medium. Such a storage medium may also be accumulated in the processor. The storage medium and processor may be arranged in ASIC. Such the ASIC may be arranged in the radio base station eNB or the mobile station UE. Further, such a storage medium or a processor may be arranged, as a discrete component, in the radio base station eNB or the mobile station UE.

Thus, the present invention has been explained in detail by using the above-described embodiments; however, it is obvious that for persons skilled in the art, the present invention is not limited to the embodiments explained herein. The present invention can be implemented as a corrected and modified mode without departing from the gist and the scope of the present invention defined by the claims. Therefore, the description of the specification is intended for explaining the example only and does not impose any limited meaning to the present invention.

1. A radio base station comprising:
a synchronization signal transmission unit configured to transmit a synchronization signal including a cell ID assigned to a subordinate cell;
a broadcast information transmission unit configured to transmit broadcast information including a virtual cell ID assigned to the subordinate cell;
a first reference signal transmission unit configured to transmit a first reference signal uniquely determined by the cell ID; and
a second reference signal transmission unit configured to transmit a second reference signal uniquely determined by the virtual cell ID, wherein
a range of values assignable as the virtual cell ID is configured to be larger than a range of values assignable as the cell ID.

2. The radio base station according to claim 1, further comprising:
a propagation delay information acquisition unit configured to acquire propagation delay information from the mobile station; and
a location information calculation unit configured to calculate location information of the mobile station based on the acquired propagation delay information.

3. A mobile station comprising:
a synchronization signal reception unit configured to receive synchronization signal in a particular cell;
a broadcast information reception unit configured to receive broadcast information in the particular cell;
a first reference signal reception unit configured to receive a first reference signal in the particular cell using a cell ID included in the received synchronization signal; and
a second reference signal reception unit configured to receive a second reference signal in the particular cell using a virtual cell ID included in the received broadcast information, wherein
a range of values assignable as the virtual cell ID is configured to be larger than a range of values assignable as the cell ID.

4. The mobile station according to claim 3, further comprising a propagation delay information transmission unit configured to calculate a propagation delay from a plurality of cells based on the second reference signal received in the plurality of cells and transmit propagation delay information indicating the propagation delay to a predetermined radio base station.
